(19) United States
(12) Patent Application Publication
(10) Pub. No.: US 2013/0076788 A1
(43) Pub. Date: Mar. 28, 2013

(54) APPARATUS, METHOD AND SOFTWARE PRODUCTS FOR DYNAMIC CONTENT MANAGEMENT

(71) Applicant: Eyeducation A. Y. LTD, Neve Ativ (IL)

(72) Inventor: ARIE BEN ZVI, NEVE ATIV (IL)

(73) Assignee: EYEDUCATION A. Y. LTD, NEVE ATIV (IL)

(21) Appl. No.: 13/625,000

(22) Filed: Sep. 24, 2012

Related U.S. Application Data
(60) Provisional application No. 61/538,950, filed on Sep. 26, 2011.

(51) Int. Cl. G06T 19/00; G06K 9/78

(52) U.S. Cl. CPC G06T 19/006; G06K 9/78
USPC 345/633

(57) ABSTRACT

The present invention provides systems and methods for dynamic content management, the method including generating content associated with an object, dynamically adjusting the content associated with the object according to a user profile to form a user-defined object-based content package, displaying at least one captured image of the identified object on the device, and uploading the user-defined object-based content package associated with the identified object to the device simultaneously with the displaying step to provide dynamic content to the user on the device.

### FIELD OF THE INVENTION

The present invention relates generally to apparatus and methods for content management, and more specifically to apparatus and methods for real-time enhanced dynamic content management.

### BACKGROUND OF THE INVENTION

In the past, vision systems were very expensive and were used mainly in security and automotive industries. Nowadays, as the cost of digital cameras has dropped significantly and every cell phone has a built-in image sensor, vision processing technology has become affordable. This advance opens up opportunities to apply this technology to significant new markets such as the consumer, publisher and gaming markets.

Vision systems can also be used to capture images which are then used as an input to another system, for example scanning an image, compare to a database and then display the image on a mobile terminal along with a fixed number of options one can do with this image is known in the industry.

Some patent publications in the field include:

US2012081529A which describes a method for generating and reproducing moving image data by using augmented reality (AR) and a photographing apparatus using the method includes features of capturing a moving image, receiving augmented reality information (ARI) of the moving image, and generating a file including the ARI while simultaneously recording the captured moving image. Accordingly, when moving image data is recorded, an ARI file including ARI is also generated, thereby providing an environment in which the ARI is usable when reproducing the recorded moving image data.

US2012079426A discloses a game apparatus obtains a real world image, taken with an imaging device, and detects a marker from the real world image. The game apparatus calculates a relative position of the imaging device and the marker on the basis of the detection result of the marker, and sets a virtual camera in a virtual space on the basis of the calculation result. The game apparatus locates a selection object that is associated with a menu item selectable by a user and is to be selected by the user, as a virtual object at a predetermined position in the virtual space that is based on the position of the marker. The game apparatus takes an image of the virtual space with the virtual camera, generates an object image of the selection object, and generates a superimposed image in which the object image is superimposed on the real world image.

Not all content is appropriate for all users. Language barriers prevent some users fro gaining full benefit of the content if it is not in a language they can understand. Some users have a certain preference as to not only which content they are interested in—but also in what format.

Thus there is a need to provide user-personalized and dynamically personalized content management

### SUMMARY OF THE INVENTION

It is an object of some aspects of the present invention to provide apparatus and methods for dynamic content management.

It is another object of some aspects of the present invention to provide software products for dynamic content management.

It is another object of some further aspects of the present invention to provide apparatus and methods for real-time enhanced dynamic content provision.

According to some aspects of the present invention, there is provided a dynamically changing content management system. The system is constructed and configured to provide a user with content on a mobile communication device, a personal computer or communication apparatus. The system allows content to be inputted and updated, and then takes in to consideration which content should be presented based upon a user profile, historical user preferences, user geographic location, time of day, age, motion, and past events. The system is constructed and configured to use the historic user data, for example, how the viewer has chosen to view content in the past (i.e., story, video, augmented reality), content which has they have recently viewed, and other factors into account in deciding on which new content/form of content is to presented to a specific user.

Further embodiments of the present invention provide for providing dynamic user-defined content management. The system generates a plurality of content associated packages (named titles) with specific objects and stores these in a database. When a user device captures one such object, whether it is an image, or audio fingerprint, the system is constructed and configured to upload a title associated with the object onto the user's communication device. In some cases, the titles may be preloaded on the user's communication device. The system is further constructed and configured to dynamically adapt and change the titles according to the specific user profile.

Some embodiments of the present invention provide a method of connecting between images, sounds and movements to multimedia expressions using a multimedia apparatus that receives image, sound and movement inputs, processes the received data and outputs voice or visual message or kinesthetic messages (i.e., vibration, buzzing, etc.) for the purpose of education, entertainment, advertisement, medical and commercial.

Some further embodiments of the present invention provide object detection recognition and tracking software, which is based on object features data, the object features data contains the data needed for the apparatus processing algorithm to detect and recognize the object.

The present invention further provides a method of preparing and relating between object images, object features data, multimedia video and audio expressions. An apparatus application recognizes the object and issues the related multimedia expressions.

The dynamically changing content management system of the present invention is constructed and configured to provide the same content in a plurality of different languages which can either be input initially, or can be added at a later time, either via the initial content database, to by being connected with an external database and updated at a later period in time.

The dynamically changing content management system of the present invention is constructed and configured to provide the content with additional material, which may be presented in the form of a story, video, audio, animation, weblink, images, text or augmented reality.

There is thus provided according to an embodiment of the present invention, a system for providing dynamic content management, the system including;
a. at least one processing element adapted to:
   i. generate content associated with an object and to store the content in a database;
   ii. receive content from other databases, either using the same processor, or from a different processor and then dynamically merge contents into one unit, or flag as being connected to another content without merging;
   iii. dynamically adjust said content associated with said object(s) according to a user profile to form a user-defined object-based content package;
b. a multimedia portable communication device associated with said user, said device comprising:
   i. an optical element adapted to capture a plurality of images of captured objects;
   ii. a microphone element adapted to capture a plurality of sounds of captured objects;
   iii. a processing device adapted to:
      a) activate an object recognition algorithm or audio recognition algorithm to detect at least one identified object from said plurality of images or audio of captured objects; and
      b) upload said user-defined object-based content package associated with said identified object to said device; and
   iv. at least one display adapted to display at least one captured image of said identified object and provide user-defined object-based content simultaneously so as to provide the dynamic content.

Additionally, according to an embodiment of the present invention, the device further includes an audio output element for outputting audio received from the system.

Additionally, according to an embodiment of the present invention, the audio output element is adapted to output audio object-associated content simultaneously with the at least one captured object image so as to provide the dynamic content. In some cases, the dynamic content is user-matched content.

Furthermore, according to an embodiment of the present invention, the title content generator is adapted to form at least one title associated with the at least one identified object. According to some embodiments, the title is typically generated on a computer or processing device in the system. The title may be stored in a database in the system over a period of time. Thereafter, at any suitable time, it may be uploaded onto a user device. Additionally or alternatively, it may be updated or generated on a user device.

Moreover, according to an embodiment of the present invention, a display is adapted to display at least some visual content associated with the title with the captured object image.

The display may be separate from the processing device, the detection on one device and display the output on another device. For example using a mobile device and a Television screen, The object detection can be with the mobile device and the multimedia output can be on the large television screen. The multimedia output on the larger screen may or may not be the same image as displayed on the mobile device.

Further, according to an embodiment of the present invention, the at least some visual content is interactive content.

Additionally, according to an embodiment of the present invention, the interactive content includes a visual menu.

Moreover, according to an embodiment of the present invention, wherein the portable communications device further includes a motion sensor for motion detection.

Further, according to an embodiment of the present invention, the portable communications device is selected from the group consisting of a cellular phone, a Personal Computer (PC), a mobile phone, a mobile device, a computer, a speaker set, a television and a tablet computer.

According to a further embodiment of the present invention, the optical device is selected from the group consisting a camera, a video camera, a Video stream, a CCD and CMOS image sensor and an image sensor.

Additionally, according to an embodiment of the present invention, the system further includes title management apparatus configured to filter the object-associated content according to a user profile and to output personalized object-associated content in accordance with the user profile.

Furthermore, according to an embodiment of the present invention, the captured objects are selected from the group consisting of an object in the vicinity of the device; an object in a printed article; an image on a still display of a device; an object in a video display, a two-dimensional (2D) object and a three-dimensional (3D) objects.

There is thus provided according to another embodiment of the present invention, a method for dynamic content management, the method including;
a. generating content associated with an object;
b. dynamically adjust the content associated with the object according to a user profile to form a user-defined object-based content package;
c. displaying the at least one captured image of the identified object on the device; and
d. uploading the user-defined object-based content package associated with the identified object to the device simultaneously with the displaying step to provide dynamic content to the user on the device.

Additionally, according to an embodiment of the present invention, the method further includes outputting audio object-associated content simultaneously with the at least one captured object image so as to provide the dynamic user-matched content

Moreover, according to an embodiment of the present invention, the method further includes forming at least one title associated with the at least one identified object.

Additionally, according to an embodiment of the present invention, the displaying step further includes displaying at least some visual content, or producing audio content, or producing a kinesthetic output associated with the title of the captured object image.

Furthermore, according to an embodiment of the present invention, the at least some visual content is interactive content.

Additionally, according to an embodiment of the present invention, the interactive content includes a visual menu, which may be fixed or one which dynamically changes based upon user profiles.

Yet further, according to an embodiment of the present invention, the method further includes filtering the object-associated content according to a user profile and to output personalized object-associated content in accordance with the user profile.

There is thus provided according to another embodiment of the present invention, a computer software product, the product configured for providing augmented reality content, the product including a computer-readable medium in which program instructions are stored, which instructions, when read by a computer, cause the computer to;
a. generate content associated with an object;
b. dynamically adjust the content associated with the object according to a user profile to form a user-defined object-based content package;
c. display the at least one captured image of the identified object on the device; and
d. upload the user-defined object-based content package associated with the identified object to the device simultaneously with the displaying step to provide dynamic content to the user on the device.

The present invention further provides apparatus and methods for displaying a “title”.

By “title” is meant, according to the present invention, a group of data associated with an object, the title comprising an icon, information, a set of objects images, object features data, sounds, sound features data, movements, and movements features data. and a set of multimedia expressions comprising video, audio, text, PDF, images, Weblinks, Youtube links, animation, augmented reality. Each object image is related to a set of multimedia expression data.

Each object can be related and linked to other object that has multimedia expressions. This enable to have a set of objects related that are related to one object and captured in different conditions and angles of the object and share the same multimedia expressions. For example an image in the museum can be taken images from different angles and distances and linked all the images to on image that has the multimedia expressions.

The present invention further provides a method for management, creation, uploading, updating and deletion of titles.

The apparatus application comprises a title selection, title search, title upload, image grabbing, sound input, speech recognition, movement detection, image, sound and movement processing, object, sound and movement detection, recognition, a tracing and multimedia output expression related to the title objects. The title may be downloaded to the apparatus from connectivity to a PC or from the network and the internet.

The apparatus of the present invention may work in network offline or online modes.

The present invention further provides systems and methods for content output, which can be automatically generated and uploaded according to age, motion, GPS, etc. or the content can be user-selected, such as, but not limited to, text-based, videos, augmented reality, text- to-speech, or based upon the user's personal request or interest.

One object of this invention is to provide a multimedia apparatus comprising image, sound and movement processing features and multimedia output expressions for the education and entertainment of users of all ages.

The apparatus is constructed and configured to run a multimedia image, sound and movement processing applications, which visually capture objects, sounds and movements in user surrounding; Data is processed for objects, sounds and movements detection and recognition. The apparatus outputs a multimedia expression. The multimedia expression comprises voice and/or display The output expression corresponds to the image, voice and movement processed data, based on current and previous recorded data and expressions.

The present invention further provides systems and methods for developing a title according to a number of images of an object, wherein the content output is linked to the number of images of the same object. For example, the images can be taken at different angles/positions/magnifications/light settings of the same image.

The present invention further provides systems and methods for object detection. The system of the present invention combines local images of captured objects (identified by the system) together with web searches for the object detection. The object detection can be performed by image processing/recognition on the user's device or by sending the image information to a server in the system, and further performing image detection using the cloud. The present invention enables both local and remote object detection/recognition.

For example, the object is in an arthropod museum with many exhibitions, Each exhibition comprises is a title. When a user visits the exhibition, and the title is not in the device, the images will be sent to the cloud for searching and according to the search results the device will download the relevant title content. For example an image of the black widow spider may be downloaded.

The apparatus comprises an image sensor (Camera, CCD or CMOS image sensor, Video stream) input for image stream, a microphone input for voice stream and motion detector for motion detection. The multimedia output comprises speakers for voice and sounds output and display device. A processing unit capable of processing images, a storage memory (Flash) and RAM memory (SDRAM, DDR and, DDR II, for example). An interface unit, an external memory interface. A connection to an external computer and an interface to a network and the internet.

The apparatus comprises a microphone input for a voice stream, the processing unit is capable of voice processing for detection and recognition of voice objects, letters, words, sentences, tones, pronunciations and the like.

The apparatus comprises a motion detector input for motion detection, the processing unit is capable of motion processing for detection and recognition of moving objects, tracking, human motion, gestures, and the like Motion can be detected by: sound (acoustic sensors), opacity (optical and infrared sensors and video image processing), geomagnetism (magnetic sensors, magnetometers), reflection of transmitted energy (infrared laser radar, ultrasonic sensors, and microwave radar sensors), electromagnetic induction (inductive-loop detectors), and vibration (triboelectric, seismic, and inertia-switch sensors), and the like.

The apparatus comprises a light source that illuminates the area in the field of view of the image sensor and improves scene condition in low light environment.

The apparatus comprises an External Memory Interface used for connectivity with External Memory, it may be in a form of a cassette, memory card, Flash card, Optical disk or any other recording means known in the art.

The External Memory Interface may be placed in a cartridge incorporated into the apparatus. The external memory comprises application code and data.

The apparatus comprises an interface unit comprises a plurality of function buttons, switches, touch screen for instructing the apparatus processor with user requests.

In accordance with one aspect of the invention, the apparatus may be in a form of a Personal Computer (PC), mobile phone, mobile device, Tablet computer, gaming device, comprising of a camera (webcam), speakers, display device and processing unit.

In accordance with another embodiment of the present invention, the system of the present invention enables a user to add personal comments to a title or object within the title on his device, either by typing, or speaking/recording information, and then be able to flag this new material, to who it is available. In other word, the user can limit access of his personal comments to public, private, or group of authorized members.

Furthermore, according to another aspect of the present invention, the system enables a user to use a talkback feature, which allows a user to comment on objects, and add their own media to an object, such as, but not limited to, a video, a text, audio content and the like. Thus, for each detected object, the user can view the media and the talkback, to which other users provided responses.

The apparatus may be in a form of a toy, a robot, a doll, a wristwatch, or other portable article.

The image processing elements detect, recognize and track an object (2D and 3D), and/or an object characteristic, a barcode a pattern and other visible characteristics that are integrated, attached or affixed to an object.

In yet another aspect of the invention, the apparatus may be used for education and learning of objects such as letters, words, numbers, mathematical calculation, colors, geometrical shapes, fruits, vegetables, pets, animals, and the like.

The apparatus may be used for learning of new languages, making the multimedia output expression in different languages.

In yet another aspect of the invention, the apparatus may be used for playing music, by detection of musical instruments, musical notes, Bands and Artists or other audio outputs and outputting multimedia music expression.

In yet another aspect of the invention, the apparatus may be used for commercial and advertisement by detection of commercial logos, trademarks, or commercial products, and outputting multimedia commercial output expression.

The apparatus comprises object detection, recognition and detection algorithm that is capable to detect and recognize given 2D and 3D objects in an image and video sequence. The object in the image may be detected in varying conditions and state such as different size, scale, rotation, orientation, different light conditions, colors change, partly obscured from view.

In yet another aspect of the invention, each given object has a feature data that used by the algorithm to recognize if the given object is in the image by finding feasible matches between object features data and image features data.

In yet another aspect of the invention, the object feature data may be prepared in advance. This may be done for example by a service utility that receive a set of objects images and extract the object features data. The object features data may be stored in compress format, this will enable to save memory space and data transfer time to download the objects features data to the apparatus. This may improve application performance and initialization time.

Adding a new object to the application comprises adding an object features data extracted from the object image. The object features data may be prepared in external location and can be downloaded to the apparatus from the network and the internet.

The apparatus application may detect one or more objects in an image.

In yet another aspect of the invention, the apparatus comprises application programs, the application comprise a set of predefined given objects images a set of object features data and a set of multimedia video and audio expressions.

The application is using the apparatus image sensor to grab a stream of images, process the image for objects detection recognition and tracking and issue a multimedia expression that is related to the objects through the apparatus speakers and display device.

In yet another aspect of the invention, In addition to image objects the above describes may be applied to sounds and motions.

In yet another aspect of the invention, the application comprises application content called Titles. According to one embodiment of the present invention, a Title comprises a title icon, information, a set of objects images, objects features data, Sounds, Sounds features data, movements, movement features data and multimedia expression data. The multimedia compression data comprises video, audio, text, PDF, images, Weblinks, Youtube links, animation, augmented reality data. The video and audio data comprises a media files and/or internet URL (Uniform Resource Locator, The address of a web page on the world wide web) address.

The title information comprises title icon, name, descriptions, categories, keywords and other information. The title multimedia expressions are related to the titles objects. Each object image, sound and movement of a title comprises object features and may at least relate to one or more multimedia expressions.

The multimedia video, audio, text, PDF, images, weblinks, Youtube links, animation, augmented reality expression may be in a form of a file or a link to an internet URL address that contains the video, audio, text, PDF, images, weblinks, Youtube links, animation, augmented reality expression (for example a link to a video file in YouTube).

The title comprises objects with a common denominator for example objects that are from movie, objects from a book, object of a commercial company, based on the same subject or having a common link.

The title content may be prepared in advance. The apparatus application may compute the title content and/or downloaded the title content. The download of a title may be through connectivity to a PC, to a network and to an internet web location.

The apparatus comprises external connectivity to a PC, network, wireless network, internet access and the like The apparatus application comprises features to access a data center and/or a web location for search and downloads of titles. The title search comprises a text search and/or image search, by capturing image with a title objects.

In yet another aspect of the invention, there is provided a content management system which enables to manage create, update and modify the title content. The service utility comprise the handling of the title icon, information (description, keyword, categories, . . . ), objects images, object features data, Sounds, Sound features data, movements, movements features data, multimedia video and/or audio expressions data (may be a file or internet web link) and the relation and connectivity of the objects to the multimedia expression. The title service utility enables to generate the objects features data.

The title service utility generates the title content used by the apparatus application.

The title service utility may run on the apparatus device, on a computer device, on an internet web base utility.

In yet another aspect of the invention, the multimedia education and entertainment apparatus may be used for games and entertainment, advertisement, commercial, medical.

The apparatus may have the capability to update, upgrade, and add new applications, titles and content to the apparatus. The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail then is necessary for a fundamental understanding of the invention, the description taken with the drawings making apparent to those skilled in the art how the several forms of the invention may be embodied in practice.

In the drawings:

FIG. 1A is simplified pictorial illustration of a multimedia portable communication device displaying a content management application, in accordance with an embodiment of the present invention;

FIG. 1B is a simplified pictorial illustration showing a multimedia output displayed on the device of FIG. 1A, in accordance with an embodiment of the present invention;

FIG. 2 is a simplified pictorial illustration of a content management application comprising items called “Titles”, in accordance with an embodiment of the present invention;

FIG. 3 is a simplified schematic of a method for dynamic content management application on the device of FIG. 1A, in accordance with an embodiment of the present invention;

FIG. 4 is a simplified pictorial illustration of system for multimedia dynamic content management, in accordance with an embodiment of the present invention;

FIG. 5 is a simplified schematic of a dynamic content application for title data management for two users, in accordance with an embodiment of the present invention; and

FIG. 6 is a simplified flowchart of a method for generating title content, in accordance with an embodiment of the present invention.

In all the figures similar reference numerals identify similar parts.

### DETAILED DESCRIPTION OF THE INVENTION

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

Exemplary implementation of the present inventive concept is better described with reference to the accompanying drawings.

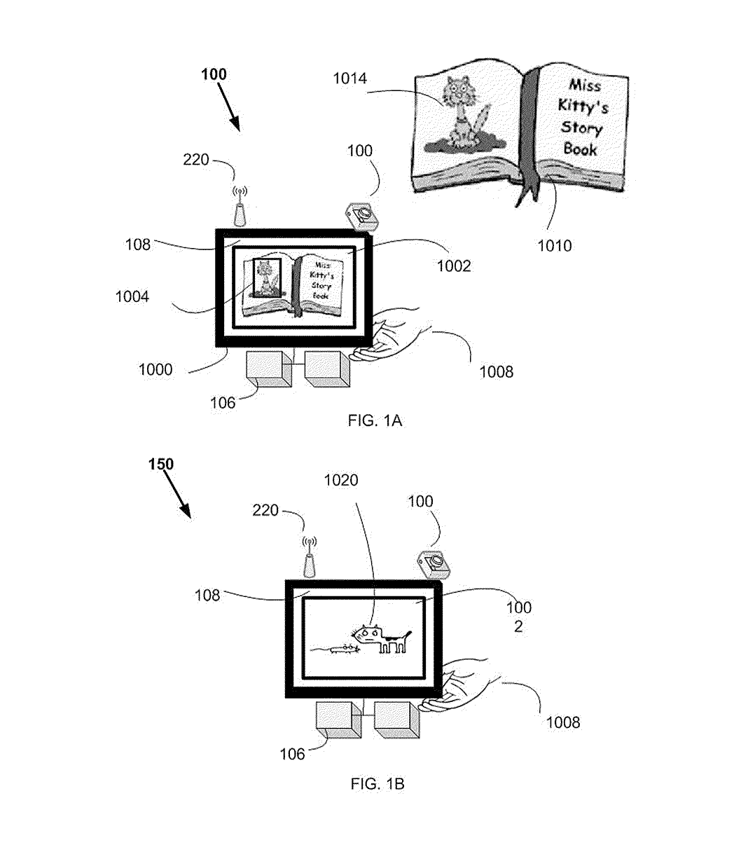

Reference is now made to FIG. 1A is simplified pictorial illustration 100 of a multimedia portable communication device 1000 displaying a content management application 1002, in accordance with an embodiment of the present invention

In FIG. 1A-a user (1008) holds a device (1000). According to some embodiments, the device is a multimedia portable communication device.

Device (1000) may be any suitable device known in the art, such as, but not limited to, is selected from the group consisting of a cellular phone, a Personal Computer (PC), a mobile phone, a mobile device, a computer, a speaker set, a television and a tablet computer.

The device typically comprises a camera (100) a network device (220) speakers (106) and a display device (108). The device (1000) is constructed and configured to run a dynamic content application (1002). The user (1008) points the device (1000) camera or image sensor (100) towards any surrounding objects, such as a book 1010.

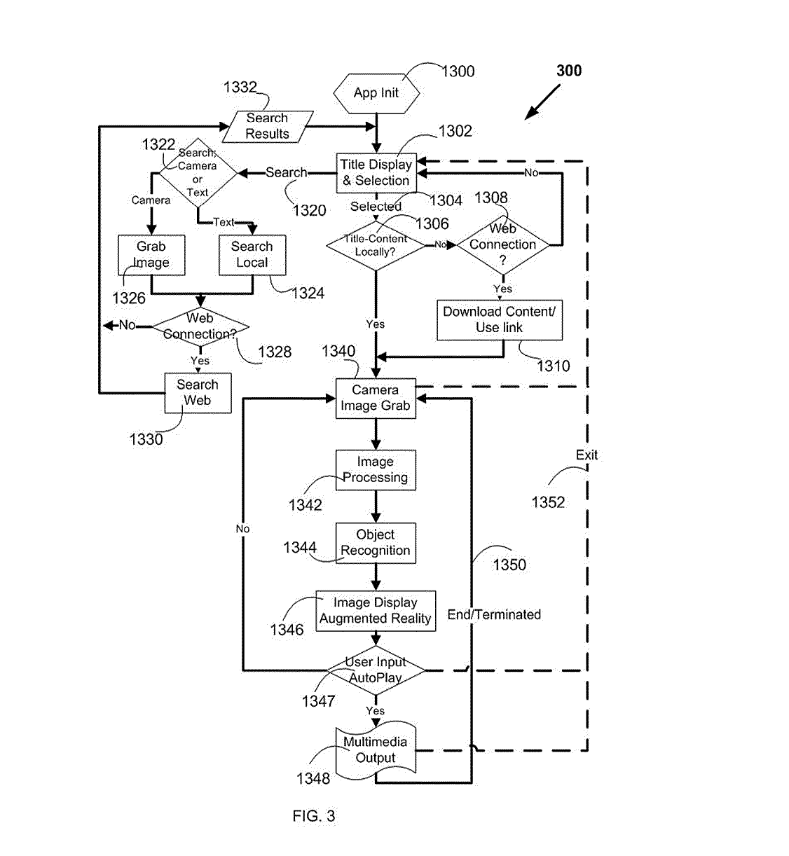

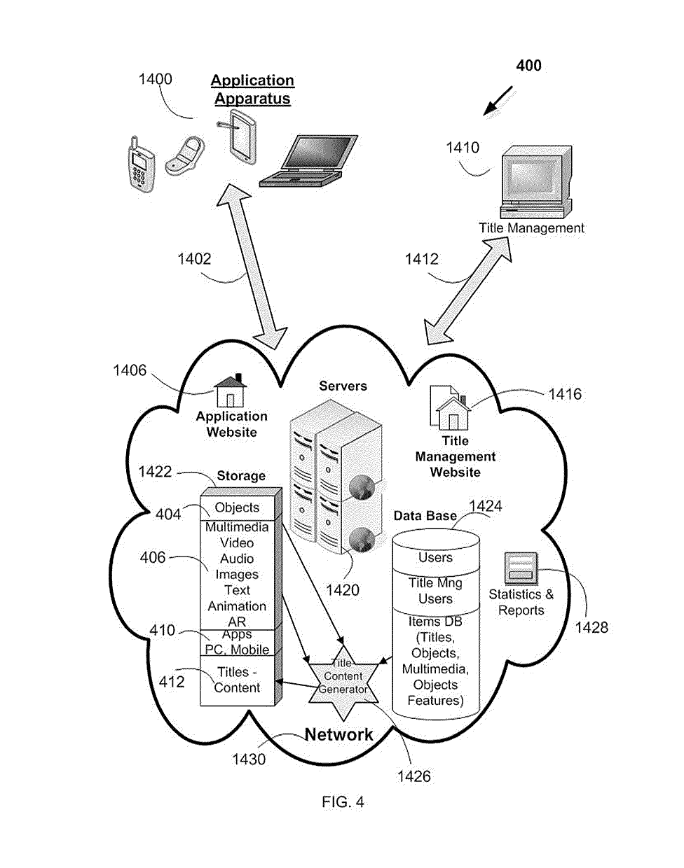

Book (1010) comprises text and object images (1014). When the device (1000) camera (100) points to the book (1010), and image (1014) is in the field of view of the device (1000) camera (100), the application (1002) in the apparatus process the images received from the camera (100) for object recognition and an object recognition algorithm in device 1000 and/or in system 400 (FIG. 4) detects and recognize the object image (1014). The device is constructed and configured to run a software package, such as a dynamic content management application (1002). Application (1002) may show the image on the device display (108) and may place a marker 1004 on the detected object, for example a rectangle (1004), surrounding the detected object image. Further details of the dynamic content application are described herein below with respect to application 300 in FIG. 3.

The application (1002) processing the image for object (1004) detection and recognition. Once a decision is made on object recognition by an object recognition algorithm, the device (1000) issues a multimedia output expression 1020.

FIG. 1B shows a simplified pictorial illustration showing a multimedia output 1020 displayed on device 1000 of FIG. 1A, in accordance with an embodiment of the present invention.

One example of a multimedia output is a video expression 1020. Device 1000 comprises speakers (106) and display device (108). The application (1002) issues issue an output expression as an audio sound (not shown) output through the speakers (106) and/or video (1020) on the display device (108).

The multimedia output expression may be any one or more of video, clips, a textual output, animation, music, variant of sounds and combinations thereof.

The multimedia output expression may be in a form of data file located locally in the device's (1000) memory, it may be located remotely on a network in system 400 (of FIG. 4) or an internet server and stream to the device (1000) through the network device (220) connectivity.

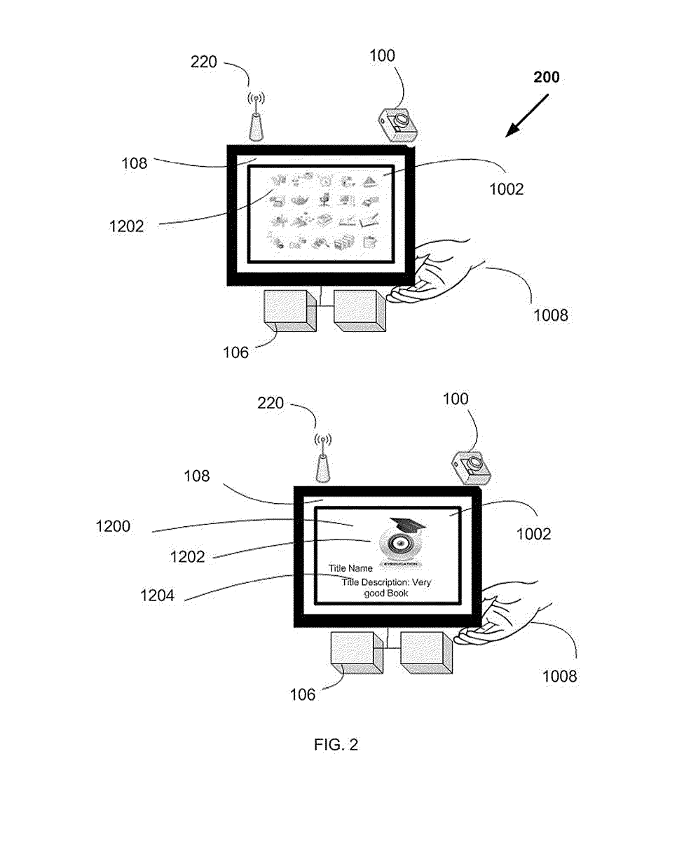

Reference is now made to FIG. 2, which is a simplified pictorial illustration of a content management application 200 comprising items called “Titles”, in accordance with an embodiment of the present invention.

A title application 1002 is constructed and configured to upload a title page 1200, comprising a title icon 1202, title information 1204, (name, description, and the like), a set of objects images, objects features data (extracted from the objects images), a set of multimedia video 1020 and audio expressions (not shown) that are related to the object images.

According to some embodiments, the title is typically generated on a computer 1410 in the system (400 of FIG. 4). The title may be stored in a database 1424 in the system over a period of time. Thereafter, at any suitable time, it may be uploaded onto a user device 1400, 1000. Additionally or alternatively, it may be updated or generated on a user device 1400, 1000.

The device (1000) application (1002) may display a list of titles available by the application. The list comprises a graphical icon list (1206) a text list, details list etc.

According to some embodiments of the present invention, a title is a package of images, other titles and multimedia files that are linked together to create image detections and further to present a data package associated with an object.

A title should preferably comprise the following:

### 1. Title Information

A title header contains the following information:
Title name: Name of the title (i.e. product name).
Short description: Short text about the title, a one sentence summary.
Detailed description.
Icon file

### Objects for Detection:

The objects is detected based on natural features that are analyzed in the target image.

Provided herewith are some typical guidelines, according to the present invention, for optimizing object detection:

Good Object Requirements:
Rich in detail
Have good (local) contrast i.e. it has both bright and dark regions
Must be generally well lit and not dull in brightness or color
Does not have repetitive patterns such as a grassy field, the facade of a modern building with identical windows, a checkerboard and other regular grids and patterns.

Each object can be related to one or more of multimedia expressions:

Video

Audio

Text, PDF

Title

Image

Weblinks

Youtube links

Animations

Augmented reality

Media:

The application supports various ways to display when object is detected:
Autoplay—When an object is detected it will automatically play the related media. Support a list of multimedia (Video, Audio, Text, PDF, images, Weblinks, Youtube links, Animation, Augmented reality) than can be played in ordered or Shuffle.
Augmented reality Marker—When an object is detected an augmented reality marker sign or animation will appear on the detected image. Pressing the Marker sign will activate the media. This function will also support a list of multimedia (Video, Audio, Text, PDF, images, Weblinks, Youtube links, Animation, Augmented reality) that can be played in ordered or shuffled. The augmented reality Marker can be a 2D and 3D image.
Popup Menu—Opens as a pop-up window menu with few options to choose from. Each menu item active a media (Video, Audio, Text, PDF, images, Weblinks, Youtube links, Animation, Augmented reality).
linked object—An object can be linked to other object media expressions.

Selecting a title by the user from the title list may open a title page (1200). The title page comprise information on the title, comprising of title icon (1202), title information (1204) comprising of title name, description on the title, promotions, etc.

An example of a title list is a books library. The set of titles are the books, Each title represent a book, The title icon is the book cover, the title information is the description of the book and the author, The title objects are the book images located in the book cover and pages. For each image object there is one or multiple video and audio data related book images.

Another example for a title is a book about dinosaur, the title name is “Great Dinosaur”, title icon will be the book cover, each dinosaur image will be transformed to an object feature data, and will have a related video media file with animation on the dinosaur.

Another example for a title is an animal story book, each image of the book animals will have a multimedia video expression showing the animals and its habitats. A title may be a set of objects from a variety of content and markets, it may be related to a movie, a toy, commercial merchandise, companies logo's, and the like

The application (1002) may update and add new titles, the application may enable the user to search and download new titles to the apparatus. The title search may be based on a text data and the search will be done on the titles information and keywords.

The user (1008) may use an image base search, by taking a picture with of the object and sending the captured image to the search engine.

Once a search result is found, the user can select to download the title content to the apparatus memory. The title content comprises title icon, information, object images, object features data, audio and video files and or links and relation data between features data and the audio and video expressions. The downloaded title content comprises part of the title content and download only items that needed by the application.

The download of title content may be from a connection to a network and the internet, The titles are located in a network/internet server. the network connectivity may be a wireless connectivity or cable connectivity to a network or computing device (PC).

According to some embodiments, the title content on servers 1420 (FIG. 4) may be compressed. This will enable the saving of memory space, such as in database 1424 and reduce the time of the title download to the device (1000). In this case the downloader and/or the application are constructed and configured to decompress the compressed title content.

Reference is now made to FIG. 3, which is FIG. 3 is a simplified schematic 300 of a method for dynamic content management application on the device of FIG. 1A, in accordance with an embodiment of the present invention.

Schematic 300 shows a method of an apparatus application comprising of title selection, title search, title download, processing of image inputs and output of multimedia expression corresponding to the input processed data.

The flowchart describes herein, is an example only, and can be implemented in various ways, orders of execution, with parts of the implementation and/or with additional features. The apparatus application comprises Initialization stage (1300), Titles display and selection (1302, 1304, 1306), Titles search (1320, 1322, 1324, 1326, 1328, 1330, 1332), Titles download (1308, 1310), Camera image grabbing (1340), Image processing (1342), Object Recognition (1344), image display and augmented reality (1346), User input/Autoplay (1347), Multimedia output expression (1348) and application exit (1352).

The application may be downloaded to apparatus 1000 through system 400 (see FIG. 4 for further details) using connectivity to an external computer device, a network, a wireless network, a cellular network, or any other means, known in the art. The application may be downloaded from a website or from application market, in example the Apps-Store, Android Market and the like.

The application will be added and displayed in the apparatus device, for example added to the apparatus applications list and to the apparatus applications icons.

The apparatus application will support update mode, this will be done through an apparatus service or by the application itself, notifying on a new updates available to download.

The apparatus application comprises Network Offline and Network Online working modes, when the apparatus device is in Network Offline mode, there is no network and internet connectivity, In this mode the title content (icon, information, objects images, objects features data and multimedia output expression, and the like) should be located on the apparatus device local memory (Flash disk, SD CARD etc.). The title content should be downloaded to the apparatus before running the application.

When the apparatus is in Network Online mode (for example—connected to a network or the internet throughout wireless or cellular network), then the application may download the title content (icon, information, objects features, multimedia output expression) from the network and the internet.

The multimedia output expression, for example, may be streamed from an internet web link using a URL web location.

The apparatus application may support a mixed of offline and online multimedia output expression, for example part of the Audio and Video data may reside locally on the apparatus memory and some will be located as a URL web links

Where the application starts in initialization of the HW and SW (1300), the application starts with a title display and selection (1302), the titles display comprises title name, title icon and title description. The title may be displayed in a list, a graphical icon display and the like, when a title is selected the application may display the selected title in the apparatus display with additional details and images, and download the updated title data.

The user may search (1320) for a new or specific title. The search options comprise a text search, a camera image search. The user selects the type of search (1322). When a text search is selected The application will search for the title in the apparatus application data located in the apparatus local memory (1324), in addition if the apparatus device is in network online (1328) then the application will send a search request to a network device, for example a website, a network server, and the like

The search will comprises search filters, for example title name, types, categories, keywords, companies, and the like.

The search results (1332) will display the matching titles, the search results data comprises the title header information (icon, name, description. etc.). The full title content will be downloaded after the user selects a specific title to download.

When a camera image search is selected (1322), the application will activate the camera and the user will capture an image (1326). When the apparatus is in network online mode (1328) an image search request is sent to a network device (1330) (i.e. internet website, network server), the network device will process the image and will send the search results (1332). When the apparatus is in network offline mode, the search may be done on the local apparatus titles content.

The apparatus application may enable the camera image search option when the apparatus is in network online mode and disable the camera image search option when the apparatus is in network offline mode.

After a title is selected (1304) the application verify that the required title content is located in the apparatus application memory (1306). If all the required title content is located, then the application will start the application loop. If the required title content is not or partly located in the application memory, then the application is required to download the title content, by methods known in the art.

If the apparatus is in network online mode (1308), then the application will download the title content (1310). After completion of the download of the title content the application will continue to the multimedia image processing application loop. If the apparatus is in Network offline mode (1308) that application will return to title display and selection (1302).

The application may support a partial download of the title content, this may be used for example as a title promotion, enabling the user to try and experience few of the title objects, prior to a full title download.

When a title is selected and located locally in the apparatus memory and the apparatus network is in online mode, the application may check with the network device if there are updates information for the title, and download the updated title data.

The title content may be compressed in the apparatus memory. The application will decompress the title content.

The multimedia image processing application loop comprises Camera image grab (1340), Image processing (1342), Object recognition (1344), Image display and augmented reality (1346), User input/Autoplay (1347) and Multimedia output (1348).

The application activates the apparatus device image sensor camera and grab the image frames (1340). The grabbed images are processed (1342), The image processing algorithm processes the image to find matching title objects features. The object recognition (1344) analyzes the processed data to determine on title objects detection. The image will be displayed with augmented reality layer (1346) on the apparatus display device, user input (1347) enable the user to activate input and a new image is captured for processing (1340). The process of camera image grab (1340), image processing (1342), Object recognition (1344) Image display (1346) and user input/Autoplay (1347) is running continuously. After completing the image processing (1342), object recognition (1344), image display (1346) and user input/Autoplay (1347), it returns to Camera image grab (1340) to process new input image data.

The object detection recognition (1344) algorithm comprises few recognition methods such as Edge matching, Grayscale matching, Features based methods, Interpretation trees, Scale-invariant feature transform (SIFT), Speeded Up Robust Features (SURF), Template matching, and the like. The object recognition can detect 2D and 3D objects.

The Image display (1346) may display the grabbed image on the apparatus display device. The grabbed image is processed by the image processing (1342) and may comprise an augmented reality layer that can display for example a marker on the object, a popup menu, multiple buttons, information and labels for example, title name, logo, text (“searching”), etc.

The augmented reality layer may help the user to recognize that he is on the application mode and not on an apparatus camera mode.

When the object recognition (1344) recognize a title objects, the title comprise with the display method and multimedia expressions for each object. The display method which is an augmented reality layer can be for example a marker (2D, 3D marker) a popup menu, a multiple buttons and labels.

The object display method can be Autoplay which enable to automatically play the multimedia expression.

The User input/Autoplay (1347) check the title display methods, when Autoplay is selected than it will activate the multimedia output (1348). When a marker or Popup menu is displayed, than the user input selecting from the popup menu, buttons, or tapping the marker will activate the related multimedia output (1348)

The multimedia output (1348) will issue an output expression to the apparatus multimedia output. The preferred multimedia output (1348) is Audio system speakers and a display device.

The image display (1346) may display the detected and recognize objects and the user may select the multimedia expression output for the object, when several objects are the detected and recognize, A markers and/or popup menu augmented reality layer can be displayed on each detected object, the user may select to which object to issue the multimedia output expression.

The multimedia expression comprises of Video, Audio, Text, PDF, images, Weblinks, Youtube links, Animation, Augmented reality, etc expressions, when the Video, Audio, Text, PDF, images, Animation, Augmented reality data is located locally on the apparatus device memory, The Video, Audio, Text, PDF, images, Animation, Augmented reality data will be played by the apparatus multimedia outputs.

When the multimedia expression, Video, Audio, Text, PDF, images, Weblinks, Youtube links, Animation, Augmented reality are not located at the apparatus 1000, 1400, local memory (not shown) and the apparatus is in network online mode, then the apparatus device will download and stream the data and play or display the multimedia output expressions.

The multimedia output (1348) can display the multimedia expression as augmented reality layer on the grabbed image, displaying both the image and the multimedia expression layer. It can display the multimedia expression in regular mode without the display of the captured image.

When the multimedia output expression completed (1350) or the user manually stopped or terminated (1350) the multimedia output, the application will continue with the multimedia image processing loop of Camera image grab (1340), image processing (1342), Object recognition (1344) Image display and augmented reality (1346) and user input/Autoplay (1347).

In yet another aspect of the invention, When the multimedia output expression is active the apparatus device may shut down the power to the apparatus image sensor camera. This will enable the apparatus to save power supply, it is mostly important when the apparatus power supplies are batteries.

The user may Exit (1352) the multimedia image processing application loop at all time and return to Title Selection (1302). When the application is not in the multimedia image processing application loop, the image sensor camera may be halt and shutdown to save the apparatus power supply.

Reference is now made to FIG. 4, which is a simplified pictorial illustration of system 400 for multimedia dynamic content management, in accordance with an embodiment of the present invention.

It should be understood that system 400 may include a global positioning system (GPS) 402 (not shown) and devices 1000, 1400 may be trackable using the GPS system 402, as is known in the art.

The environment of the apparatus comprises apparatus devices (1400), (1000, FIG. 1), Network connectivity (1402), Title Management (1410), title management network connectivity (1412), and optionally GPS system 402. A network and or an internet (1430), Application website (1406), Title management website (1416), servers (1420), storage (1422), database (1424), title content generator (1426) and Statistics and reports (1428).

The apparatus device (1400) and the title management (1410) may run on the same apparatus device, with the same website (1406, 1416) the same network connectivity (1402, 1412) and by the same user. It is separated in this drawing for the clarity of the description.

The Network (1430) may be a computer network, Local Area Network (LAN), Wide area network (WAN), Virtual Private Network (VPN), company network, The Internet network and the like, as is known and practiced in the art. The network may be allocated at the Cloud computing network. (Cloud computing provides computation, software, data access, and storage services that do not require end-user knowledge of the physical location and configuration of the system that delivers the services.).

The connection of the apparatus to the network (1402, 1412) is through the apparatus network interface, it may be a physical network cable, preferred USB or standard network cable, it may be a wireless connectivity, preferred Wi-Fi, Cellular connectivity, Bluetooth, and the like, as is known and practiced in the art.

The Servers (1420) are in communication with at least one physical computer (1410), located in the network (1430) and used for computing and management of the websites (1406, 1416), applications and titles downloads, Titles management and creation (1426), Storage (1422) management, database management (1424) and manage the statistical and reports (1428).

The Storage (1422) located in the network (1430) contains the applications and title content, title objects images, the multimedia Video, Audio, Text, PDF, images, Animation, Augmented reality data, and management data.

As was elaborated hereinabove, title data stored in storage memory 1422, may include objects 404, multimedia content 406, applications 410 for mobile and/or PCs and titles content 412 and combinations thereof.

The Database (1424) located in network 1430, contains the information of users 1008. The information may include one or more of data associated with the users 420, users' title management data 422 and items database 424. The items database comprises user-associated titles including images, video, audio, object features and the like and combinations thereof.

Management of the titles content comprises determining the relation of the title components comprising of title information, objects images, multimedia expression Video, Audio, Text, PDF, images, Weblinks, Youtube links, Animation, Augmented reality.

The Title-Content generator (1426) a service utility that receives the title object images and multimedia expression data and creates object features data, that is required by the image processing algorithm to detect and recognize the titles' objects.

The statistical and reports (1428 and log of users, titles popularity, and the like, is saved in database 1424 and/or in storage memory 1422.

The user may manage titles, upload titles content comprising of title information, images, multimedia Video, Audio, Text, PDF, images, Weblinks, Youtube links, Animation, Augmented reality data, create titles object features and prepare titles for application downloads.

The User downloads the application and titles content to the apparatus device (1400). The download may be from the network and/or internet website (1406) or from online software store for application for example Apple App-Store, Android Market.

The application 1002 (FIG. 1B) running on the apparatus, such as device 1400, 1000, display a list of titles or title icons 1202, the titles may be located locally on the apparatus device or search and downloaded from the network 1430 (FIG. 4). The apparatus may connect to the network (1402) application website (1406) and/or connect (1402) directly with the server (1420) to get the titles information.

Once a title is selected, the apparatus application checks for the title content data, if the title content stored locally on the apparatus (1400), the application starts the multimedia image processing loop. If the title content is not stored locally, then the application downloads from the network (1430) the selected title content data.

The application then activates the device camera grab images, runs image processing algorithm and display on the apparatus device the processed image. This runs continuously, until the image processing algorithm detects the title object and issue a multimedia output expression an audio and or a video data. After completion of the output expression the application continues with the image capturing and image processing algorithm loop until new title object is recognized and so on.

When the apparatus application multimedia output expression is a web URL link, the apparatus will stream the multimedia data from the network (1430).

The apparatus application will support automatic updates using the network connectivity to the website (1406) and the servers (1420).

The user may use the apparatus device or the network to manage the titles. The user can create titles, for each title the user upload images, audios, video's data, URL links, and the like. After completion of the title data upload, the user activates the Title Content Generator (1426) to create the Title Content. After completion of this stage the Title Content is ready to be downloading by the user to the apparatus application.

The user may use a the Title Management website (1416) to manage the titles, through the title web connectivity (1412), The user may use Title management utility running on his apparatus device (1410), and connecting with the server (1412) the utility has access to the network (1430) to upload/download/modify titles.

The Application website (1406) enables the user to download the application to the apparatus through the website network connectivity (1402). The Application website (1406) comprises User login, Titles list, application and titles downloads and search. It may support few front end languages display.

The user may set the title accessibility as a public title that can be access by all, or a private title and enable the title view to a selected users, for example work colleague, students, friends, facebook friends etc.

The Application website running on the apparatus web browser detects the type of the apparatus device (1400) the user is using, It may be a computer device, a mobile device running a browser, a gaming device, a tablet device, gaming device, and the like The user will download the application that match to his apparatus device (1400). The database (1424) will keep record history of all applications downloaded by the user.

The Application website display the titles list taken from the storage (1422) and database (1424) the selected titles will be arranged according to the selected language and country location.

In yet another aspect of the invention, the application website (1406) may request the user (1008, FIG. 1A) to register to the website, this may enable the user to download the application to the apparatus, such as device 1000, 1400. Once the user is reiterated, the browser may keep the user details and will make an automatic login. The user login will comprise an E-mail address or user name and Password fields. The following information may be filled during registration: First name, last name, Email address, password, Date of birth, country, city, and the like

The Application website may display the titles list, The Title list display comprises the title icon and name. The page will present a list of titles icons & names.

The titles can be sort and ordered according to the following: most popular, top download, name, latest entry, and the like When selecting a title, a title page will open displaying the title icon, title name, title description, user reviews, and the like

The Application website (1406) comprises title search and advanced search comprises title name, types, keywords, and the like The title search may be executed by the server (1420), the storage (1422) and the database (1424)

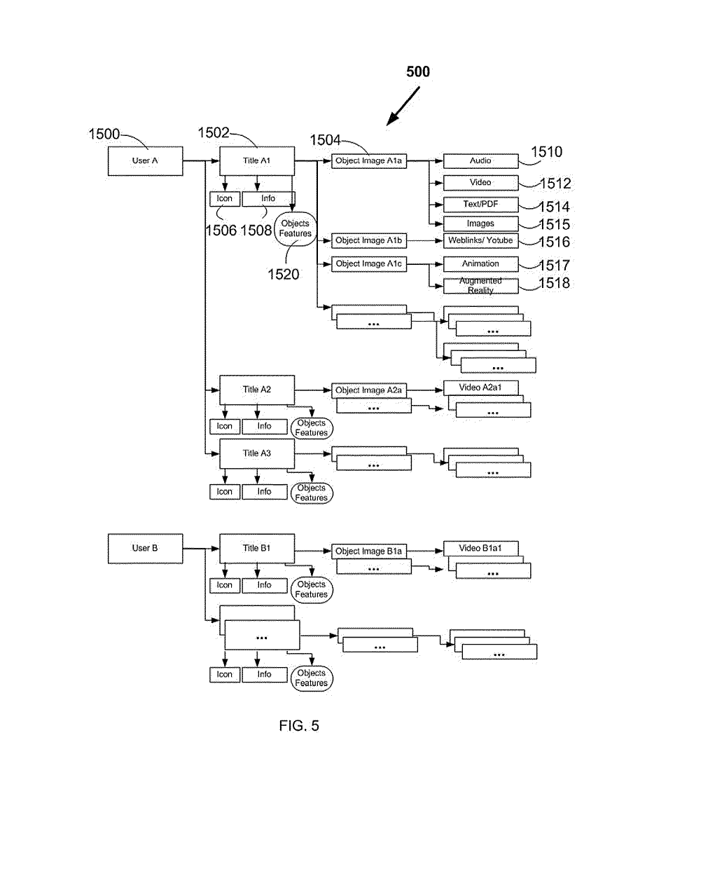

Reference is now made to FIG. 5, which is a simplified schematic of a dynamic content application 500 (known herein as “application”) for title data management for two users, in accordance with an embodiment of the present invention. In yet another aspect of the invention,

A title (1502) comprises the following:
Icon (1506)
Information (1508) comprises name, description, categories, keywords, and the like
Objects Images (1504) set of objects images
Objects features data (1520) extract of objects features from the object images.
Multimedia Expression
   Audio data (1510) comprises a set of audio media file and/or an internet URL address
   Video data (1512) comprises a set of video media file and/or a internet URL address
   Text/PDF data (1514) comprises a set of Text and PDF media file and/or a internet URL address
   Images data (1515) comprises a set of images media file and/or a internet URL address
   weblinks data (1516) comprises a set of internet URL address to a web sites and youtube links
   Animation data (1517) comprises a set of animation media file and/or a internet URL address
   Augmented reality data (1518) comprises a set of augmented reality media file and/or a internet URL address

Each object image (1504) of the title (1502) has a set multimedia expressions (1510, 1512, 1514, 1515, 1516, 1517, 1518) related to the object image.

The multimedia expression comprises an Audio data (1510) and/or Video data (1512) and/or Text PDF data (1514) and/or Images data (1515) and/or Weblinks/Youtube data (1516) and/or Animation data (1517) and/or Augmented reality data (1518). The multimedia data may be a media files or a internet URL link.

Each object image (1504) may have few Audio (1510) and/or Video (1512) and/or Text PDF data (1514) and/or Images data (1515) and/or Weblinks/Youtube data (1516) and/or Animation data (1517) and/or Augmented reality data (1518) expressions and it comprises both media files and URL links.

The User (1500) manages the titles (1502), he may upload modified and update titles (1502), Icons (1506), Information (1508), object images (1504) and multimedia expression data (1510, 1512, 1514, 1515, 1516, 1517, 1518), create objects features data (1520), delete titles (1502), and the like to his device 1000, 1400 in system 400.

Adding of a new title (1502) for example to a web interface comprises the following steps:

A. Title Header
1. Upload title icon (1506), the uploaded image may be converted to the application specific format.
2. Fill title information (1508) comprises name, description, categories, keywords, and the like

B. Object Images and Multimedia Expressions

1. Upload Object Image (1504) the uploaded image may be converted to application format. If the uploaded image is not valid an error will be displayed.

2. Upload multimedia expression (1510, 1512, 1514, 1515, 1516, 1517, 1518) for the object image (1504) comprising of Audio (1510) and video (1512) and Text PDF (1514) and Images (1515) and Weblinks/Youtube (1516) and Animation data (1517) and Augmented reality (1518) data. There are two types of data: files and links:
Video/Audio/Text/PDF/images/Animation, Augmented reality files—Upload media file. The uploaded media file will be converted to application format. If the uploaded audio/video file is not valid an error will be displayed

Video/Audio/Text/PDF/images/Weblinks Youtube links/Animation, Augmented reality Links—Add a link. If the link of the audio/video is not valid, an error will be displayed.

After loading of multimedia expression data (1510, 1512, 1514, 1515, 1516, 1517, 1518) is completed the total amount of title storage is updated.

3. If there are additional multimedia expressions (1510, 1512, 1514, 1515, 1516, 1517, 1518) files and links for the object image (1504), then go to step 2.

4. If there are additional Object Images (1504) then go to step 1.

The user information (1500) and titles content may be stored in the user apparatus memory or at the network (1430) storage (1422) and database (1424).

The media files comprises Object images (1504), icons (1506), multimedia expressions data (1510, 1512, 1514, 1515, 1516, 1517, 1518) may be converted to the applications format that matched the apparatus device. There may different types of apparatus with different operation system and media players, the media conversion may convert the media files for all types of supported apparatus. The original media file and the converted media file may be saved in the apparatus memory and/or network storage (1422).

If a media data cannot be converted or an error occurs during the conversion process, an error will be displayed to the user.

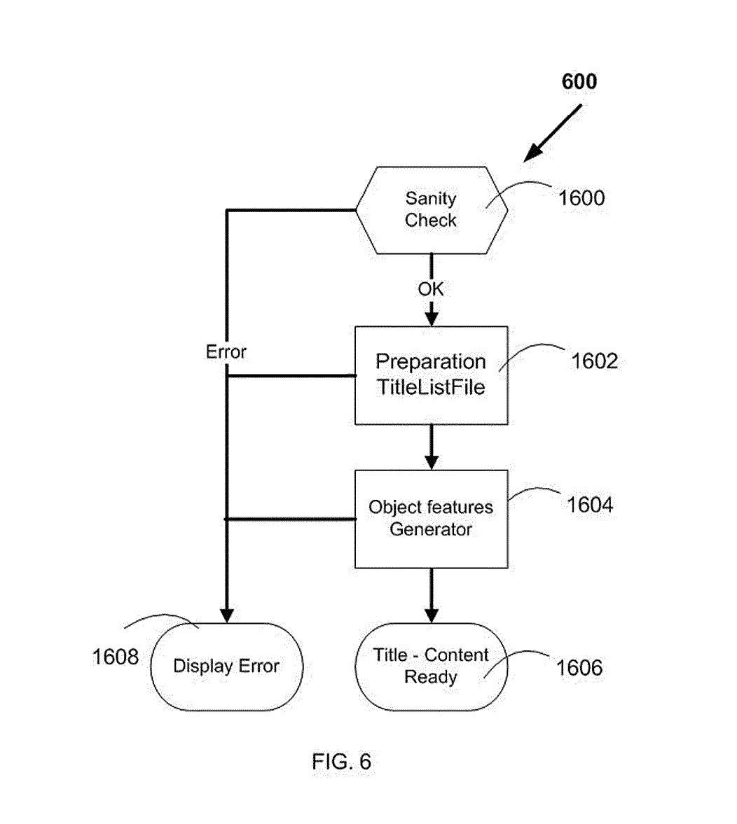

Reference is now made to FIG. 6, which is a simplified flowchart 600 of a method for generating title content, in accordance with an embodiment of the present invention.

In yet another aspect of the invention, FIG. 6 describers a method for generation title content. The title content generator (1426) comprises Sanity check (1600), Preparation of Title list file (1602), object features generator (1604), title content ready (1606) and if an error occurs during the process a display error (1608).

After the user completes the uploads of the title data comprise the objects images and the related multimedia expression data, Video, Audio, Text, PDF, images, Weblinks, Youtube links, Animation, Augmented reality files and/or links, the user is ready to create the title content for the title.

The title content generator comprises the following steps:
Sanity checks (1600) Validates that all the data and information needed are valid.

It comprises the following verification:
Title icon valid
Objects Images validity
Multimedia Video, Audio, Text, PDF, images, Animation, Augmented reality files validity
Multimedia Video, Audio, Text, PDF, images, Weblinks, Youtube links, Animation, Augmented reality URL links validity
Objects Images relation to Video, Audio, Text, PDF, images, Weblinks, Youtube links, Animation, Augmented reality data
Verification that all object images has Video, Audio, Text, PDF, images, Weblinks, Youtube links, Animation, Augmented reality relations
Total size of title Content data
Preparation (1602)—system 400 prepares the data and files that are needed to the object feature generator (1604). This may be performed, for example from computer 1410 by a system manager. This process may create a list of the object images and multimedia expression. Each row of the file will have the object image name and then the multimedia expression names.
Object Features Generator (1604) Processing on the object images to extract the objects features needed by the object recognition algorithm to recognize the titles objects. The algorithm uses as an input the objects images and multimedia expressions and output an object features.
Title-Content ready (1606) Update the database on a new (or modified) title-Content. Issue a success message to the website page. The title content may be compressed to save storage space and improve user download time.
Display Error (1608) In case of validation process (1600) failure, the process will halt and error message will be displayed on the web page. This will include instruction how to fix the error and what to do next.

After successful completion to generate the Title-Content, The user may run testing and proof check to verify that the new Title-content is running and working properly on the apparatus device application. Completion of the verification, the user approves and enables the title to be published and download by the users.

Some embodiments of the invention are herein described, by way of example only. For purpose of explanation examples are set forth based in image processing in order to provide better description of the invention. However, it will also be apparent to one skilled in the art that the invention is not limited to the examples described herein and applied to sound and motion.

In one general aspect of the invention, a multimedia image processing apparatus comprises a camera image sensor for image stream input, a microphone for voice stream input, a motion detector for motion detection input, a Processing and control platform capable of image signal processing of the images captured by the image sensor. The processing and control platform processes the input images stream for objects detection, recognition and tracking from the images.

The processed data is stored in memory with the history of previous detected data.

The processing and control platform processes and calculates the output expression based on the new image processed data and comprises the previous history data to determine the multimedia output expression. The multimedia expression may be output through the apparatus speakers and display device.

In yet another aspect of the invention, the image object detection recognition and tracking comprises faces detection and recognition, emotions, face tracking, letters, words, numbers, math calculation, geometrical shapes, colors, fruits, vegetable, pets and any other objects captures by the image sensor.

In yet another aspect of the invention, The application running on the apparatus comprises titles. Each title comprises object features data that are used by the image processing algorithm to recognize the object. Each object has a related set of multimedia video and/or audio expression that are played by the apparatus when the related object is detected. The multimedia expression may be in a form of a multimedia file or an internet web URL link.

In yet another aspect of the invention, the apparatus application may, compute the object images and extract the object features data at the initialization stage of the application.

In yet another aspect of the invention, the title content comprising the object detected features and the multimedia expression are prepared and created in advance. A service utility may be used for title content preparation and generation. The title content may be downloaded to the apparatus storage memory. The application running on the apparatus will load the prepared title content comprising the object features data to the apparatus RAM memory.

This method of loading the prepared title content from the storage memory may improve the application performance comprising of improving the initialization time.

In yet another aspect of the invention, the apparatus may also be interactive with the learner comprising learning activities, questions answering, riddles solving, Challenging, Finding, Counting, Story-telling, games and entertainment.

The apparatus may be in a form of a stand-alone embedded electronic platform wrapped by a user friendly cover, preferred a toy, a robot, a doll and the like.

The apparatus may be in other form as a Personal Computer (PC), desktop, laptop, Notebook, Net book, mobile device, mobile phone, smart phone, PDA, tablet, electronic gaming device, wristwatch, MP3 player, MP4 player and the like

In yet another aspect of the invention, the method and apparatus, enables transforming any object into an interactive experience using object recognition technology. A method and a service utility that match interactive multimedia expression content (i.e. song, sounds, short animations, films, jokes and the like) to an object image. The service utility will allow companies and individuals to upload photos and matching content and transform it into an interactive application.

Then, once a person using the apparatus application points any camera be it smart phone or a webcam to that object, the application will recognize the image and play the matching interactive content.

The method and apparatus bring objects and images to an interactive multimedia experience—be it pages in a book, family pictures, bedding, street signs, stickers, dolls, games objects (i.e. cars, Lego) or any other form of objects and images.

The apparatus application enables the user to combine ‘old fashioned’, ‘pre digital’ toys and books, signs, printed catalogs and the like, with new and interactive experience, it will be attractive for user who wish to get an experience of connecting between real objects to interactive, educational, fun, commercial, medical or other content.

The user of the apparatus application comprises the following application operation, At first the user select a title of his interest. This may be a book the user have, a toy, a doll, a picture, or images on a wall. Once the title is selected, the user points the apparatus device image sensor camera to the objects in his surrounding that are related to the title. Once an object is detected by the apparatus, the apparatus will issue a multimedia expression.

As an example, The user may be a child with a set of dinosaurs toys, The user select the dinosaur title in the apparatus device application and points the apparatus camera to the dinosaur toys, Once the dinosaurs toy is detected by the apparatus an audio sound is played with the dinosaur voice and a video is played in the apparatus display device showing a movie about that dinosaur. In another example, the child may paint on a coloring book, once the child points the apparatus camera to the painted image in the book, the apparatus detects the painted image and issue a related animation video.

In yet another aspect of the invention, the method and apparatus for multimedia image processing application is to enable the book publishers a service utility that brings books to life so that they can further enhance the experience for their readers by making traditional books more interactive, educational and fun. The service utility will enable publishers to easily upload objects images and associated multimedia expression content. For example a child pointing the apparatus camera (for example mobile device, gaming device, smart phone, iPhone, Android) to a story in a book and hearing the story read by the author, or appointing to a photo of a dinosaur to enjoy the sound of that dinosaur in its natural environment with a short explanation or a related animation displayed on the apparatus display device. Once the book title content is downloaded to the apparatus application the reader can point the image sensor to the images of the book and receive a multimedia expression.

The interactive book will contain, for example, a description and an internet web link with the details on the application and book title and installation instruction. The description may be printed in the book or as a label sticker that is attached to the book.

In yet another aspect of the invention, the method and apparatus for multimedia image processing application is to enable the toys companies a service utility that brings toys to life so that they can further enhance the experience for their players by making toys more interactive, educational and fun. The service utility will enable toys companies to easily upload toys objects images and associated multimedia expression content. For example a child playing with famous movie toy, pointing the apparatus camera, to the toy and seeing an animation movie clip of the toy in the apparatus device display. Once the toy title content is downloaded to the apparatus application the player using the apparatus application can point the image sensor to the toy and receive a multimedia expression.

In yet another aspect of the invention, the method and apparatus for multimedia image processing application is to enable the music companies a service that brings music to life so that they can further enhance the experience for their users by making music instruments, CD's and the like more interactive, educational and fun. The service will enable music companies to easily upload musical objects images of for example musical instruments, musical notes, bands and artists, musical logo's, musical names or other audio associated therewith or associated multimedia expression content.

For example a user points the apparatus camera 100 (FIG. 1A), to a musical instrument and listening to the instrument sound from the apparatus speaker, a user pointing the apparatus camera to a famous artist image and seeing a musical clip of the artist in the apparatus display. Once the musical title content is downloaded to the apparatus application the user can point the image sensor to the musical objects and receive a multimedia expression.

In yet another aspect of the invention, the method and apparatus for multimedia image processing application is to enable the advertising and business companies a service that enhanced their product experience and usage to the user customer, making the product more informative, interactive, educational and fun. The service utility will enable advertising and business companies to easily upload objects images and associated multimedia expression content. For example a user pointing the apparatus camera to a company product or a logo and receive a multimedia expression on the apparatus output. Once the product title content is downloaded to the apparatus application the user can point the apparatus image sensor to the product and receive a multimedia expression.

In yet another aspect of the invention, the method and apparatus for multimedia image processing application is used for educational purposes, to enable education content a service utility that brings educational material to life so that they can further enhance the experience for the learner by making traditional educational material more interactive, educational and fun. The service utility will enable educational content supplier to easily upload educational objects images and associated multimedia expression content. For example a student pointing the apparatus camera to a study book images and getting enhanced educational information on the pointed object. Once the educational title content is downloaded to the apparatus application the learner can point the image sensor to the images of the educational material and receive a multimedia expression.

In yet another aspect of the invention, the method and apparatus for multimedia image processing application may enable users to use the service in a personalized way. For example a grandfather picture can transform into a newly uploaded personal greeting when a kid points a camera to it.

The method and apparatus for multimedia image processing can be applied to any sector, market and industries. The apparatus and application can be used for multiple markets.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

What is claimed is:

1. A system for dynamic content management, the system comprising:
a. a processing element adapted to:
i. generate content associated with an object and to store the content in a database; and
ii. dynamically adjust said content associated with said object according to a user profile to form a user-defined object-based content package;
b. a multimedia communication device associated with said user, said device comprising:
i. an optical element adapted to capture a plurality of images of captured objects;
ii. a processing device adapted to:
a) activate an object recognition algorithm to detect at least one identified object from said plurality of images of captured objects; and
b) upload said user-defined object-based content package associated with said identified object to said device; and
iii. a display adapted to display at least one captured image of said identified object and provide user-defined object-based content simultaneously so as to provide the dynamic content.

2. A system according to claim 1, wherein said device further comprises an audio output element for outputting audio received from said system.

3. A system according to claim 2, wherein said audio output element is adapted to output audio object-associated content simultaneously with said at least one captured object image so as to provide the content.

4. A system according to claim 1, wherein said processing element is further adapted to receive content from other databases, either using the same processor, or from a different processor and then dynamically merge contents into one unit, or flag as being connected to another content without merging.

5. A system according to claim 1, wherein said device further comprises a microphone element adapted to capture a plurality of sounds of captured objects.

6. A system according to claim 1, wherein said system further comprises a title content generator, which is adapted to form at least one title in said system associated with said at least one identified object.

7. A system according to claim 6, wherein said display is adapted to display at least some visual content associated with said title with said captured object image.

8. A system according to claim 1, wherein said system further comprises an external display adapted to display at least some visual content associated with said title with said captured object image.

9. A system according to claim 1, wherein said dynamic content is interactive content.

10. A system according to claim 9, wherein said interactive content comprises a visual menu or marker. A system according to claim 1, wherein said portable communications device further comprises a motion sensor for motion detection.

11. A system according to claim 1, wherein said portable communications device is selected from the group consisting of a cellular phone, a Personal Computer (PC), a mobile phone, a mobile device, a computer, a speaker set, a television and a tablet computer.

12. A system according to claim 1, wherein said optical element is selected from the group consisting a camera, a video camera, a Video stream, a CCD and CMOS image sensor and an image sensor.

13. A system according to claim 1, further comprising title management apparatus configured to filter said object-associated content according to a user profile and to output personalized object-associated content in accordance with said user profile.

14. A system according to claim 1, wherein said captured objects are selected from the group consisting of an object in the vicinity of the device; an object in a printed article; an image on a still display of a device; an object in a video display.

15. A method for dynamic content management, the method comprising:
a. generating content associated with an object;
b. dynamically adjust said content associated with said object according to a user profile to form a user-defined object-based content package;
c. displaying said at least one captured image of said identified object on said device; and
d. uploading said user-defined object-based content package associated with said identified object to said device simultaneously with said displaying step to provide dynamic content to said user on said device.

16. A method according to claim 15, further comprising outputting audio object-associated content simultaneously with said at least one captured object image so as to provide said dynamic content.

17. A method according to claim 15, further comprising forming at least one title associated with said at least one identified object.

18. A method according to claim 17, wherein said displaying step further comprises displaying at least some visual content associated with said title of said captured object image.

19. A method according to claim 15, wherein said at least some visual content is interactive content.

20. A method according to claim 19, wherein said interactive content comprises a visual menu.

21. A method according to claim 17, further comprising filtering said object-associated content package according to a user profile and to output personalized object-associated content in accordance with said user profile.

22. A computer software product, said product configured for providing dynamic content management, the product comprising a computer-readable medium in which program instructions are stored, which instructions, when read by a computer, cause the computer to:
a. generate content associated with an object;
b. dynamically adjust said content associated with said object according to a user profile to form a user-defined object-based content package;
c. display said at least one captured image of said identified object on said device; and
d. upload said user-defined object-based content package associated with said identified object to said device simultaneously with said displaying step to provide dynamic content to said user on said device.

23. A system for dynamic content management, the system comprising:
a. a processing element adapted to:
i. generate content associated with an object and to store the content in a database;
ii. access data from an external database to obtain content associated with said object; and
iii. dynamically adjust said content associated with said object according to a user profile to form a user-defined object-based content package;
b. a multimedia communication device associated with said user, said device comprising:
i. an optical element adapted to capture a plurality of images of captured objects;
ii. a processing device adapted to:
a) activate an object recognition algorithm to detect at least one identified object from said plurality of images of captured objects; and
b) upload said user-defined object-based content package associated with said identified object to said device; and
iii. a display adapted to display at least one captured image of said identified object and provide user-defined object-based content simultaneously so as to provide the dynamic content.

24. A system according to claim 23, wherein said device further comprises an audio output element for outputting audio received from said system.

25. A system according to claim 24, wherein said audio output element is adapted to output audio object-associated content simultaneously with said at least one captured object image so as to provide the content.
